(19) United States
(12) Patent Application Publication
(10) Pub. No.: US 2008/0074683 A1
(43) Pub. Date: Mar. 27, 2008

(54) IMAGE FORMING METHOD, IMAGE FORMING APPARATUS, AND IMAGE FORMING SYSTEM

(76) Inventors: Yasuharu Yanamura, Tokyo (JP); Yasuyuki Igarashi, Kanagawa (JP); Nobuyuki Iwata, Kanagawa (JP); Tomoyuki Takahira, Kanagawa (JP); Saori Iura, Tokyo (JP)

Correspondence Address: DICKSTEIN SHAPIRO LLP, 1825 EYE STREET NW, Washington, DC, 20006-5403, US

(21) Appl. No.: 11/849,933

(22) Filed: Sep. 4, 2007

(30) Foreign Application Priority Data
Sep. 5, 2006 (JP) 2006-239933

(51) Int. Cl. G06K 15/02; G06K 15/00

(52) U.S. Cl. 358/1.2; 358/1.16

(57) ABSTRACT

An image forming apparatus includes a communication unit, a converting unit, an image-forming unit, a storage unit, and a control unit. The communication unit receives a print job. The converting unit converts print data of the print job to image data. The image-forming unit forms an image based on the image data. The storage unit stores therein a receipt log (access log) and an image forming log (print log) of the print job. The control unit checks, after the receipt log is stored in the storage unit, whether an available space on the storage unit is equal to or more than a predetermined size, and suspends receipt of a new print job when the available space is less than the predetermined size.

### CROSS-REFERENCE TO RELATED APPLICATIONS

The present application claims priority to and incorporates by reference the entire contents of Japanese priority document, 2006-239933 filed in Japan on Sep. 5, 2006.

### BACKGROUND OF THE INVENTION

1. Field of the Invention

The present invention relates to a technology for storing logs.

2. Description of the Related Art

For a security reason, a log is kept in image forming apparatuses. However, if a log memory reaches its full capacity with no available space for a new log, an old log is overwritten with the new one, resulting in loss of necessary logs. Japanese Patent Application Laid-open No. 2006-41764 discloses a conventional technology for storing a log that may cause an overflow of the capacity of a log storage area. In this method, importance is assigned to a log when the log is stored. When the capacity of the log storage area is to be exceeded, a log having low importance is deleted to secure a log storage area, and a log is stored in the secured area.

With the conventional technology, however, because a log having low importance is deleted, a complete record of logs cannot be kept.

### SUMMARY OF THE INVENTION

It is an object of the present invention to at least partially solve the problems in the conventional technology.

According to an aspect of the present invention, an image forming method includes receiving a print job; storing a first log of receipt of the print job in a storage unit; checking, after the storing, whether an available space on the storage unit is equal to or more than a predetermined size; suspending receipt of a new print job when the available space is less than the predetermined size; converting print data of the print job to image data; forming an image based on the image data; and storing a second log of formation of the image in the storage unit.

According to another aspect of the present invention, an image forming apparatus includes a communication unit that receives a print job; a converting unit that converts print data of the print job to image data; an image-forming unit that forms an image based on the image data; a storage unit that stores therein a first log of receipt of the print job and a second log of formation of the image; and a control unit that checks, after the first log is stored in the storage unit, whether an available space on the storage unit is equal to or more than a predetermined size, and suspends receipt of a new print job when the available space is less than the predetermined size.

According to still another aspect of the present invention, an image forming system includes a host that issues a first print job, and a second print job after the first print job; and an image forming apparatus. The image forming apparatus includes a communication unit that receives the first print job from the host; a converting unit that converts print data of the first print job to image data; an image-forming unit that forms an image based on the image data; a storage unit that stores therein a first log of receipt of the first print job and a second log of formation of the image; and a control unit that checks, after the first log is stored in the storage unit, whether an available space on the storage unit is equal to or more than a predetermined size, suspends receipt of the second print job when the available space is less than the predetermined size, and sends an error message to the host to notify the host of suspension of receipt of the second print job. The host displays the error message on a display unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view of an image forming apparatus according to an embodiment of the present invention;

FIG. 2 is a block diagram of an image processing system of the image forming apparatus;

FIGS. 3 and 4 are examples of input screens displayed on a touch panel of an operation unit shown in FIG. 1;

FIG. 5 is a schematic diagram of a log storage area on a hard disk drive (HDD) shown in FIG. 2;

FIG. 6 is another example of input screen displayed on the touch panel;

FIG. 7 is a flowchart of a print job process performed by a central processing unit (CPU) shown in FIG. 2;

FIG. 8 is a timing chart of operation in near-full state of a log storage area in the print job process;

FIG. 9 is an example of a warning screen displayed on the touch panel;

FIG. 10 is another timing chart of operation in near-full state of the log storage area in the print job process;

FIG. 11 is an example of an error-display screen displayed on the touch panel;

FIG. 12 is a schematic diagram of a print system in which a personal computer sends print job data to the image forming apparatus;

FIG. 13 is a schematic diagram of a log management system in which log data of the image forming apparatus is stored in a server;

FIG. 14 is a schematic diagram of another print system in which a plurality of personal computers and a server send print job data to the image forming apparatus; and

FIG. 15 is a schematic diagram for explaining log management in which an administrator transfers log data of the image forming apparatus to a server or an external storage medium and deletes the log data from the image forming apparatus.

### DETAILED DESCRIPTION OF THE PREFERRED EMBODIMENTS

Exemplary embodiments of the present invention are explained in detail below with reference to the accompanying drawings.

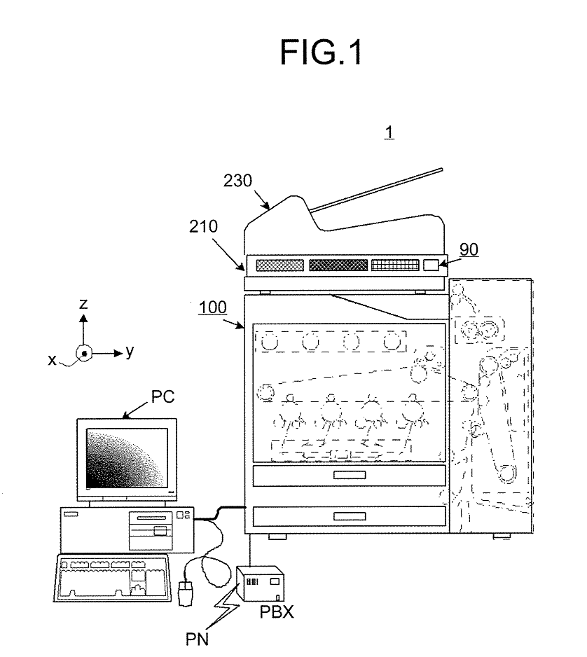

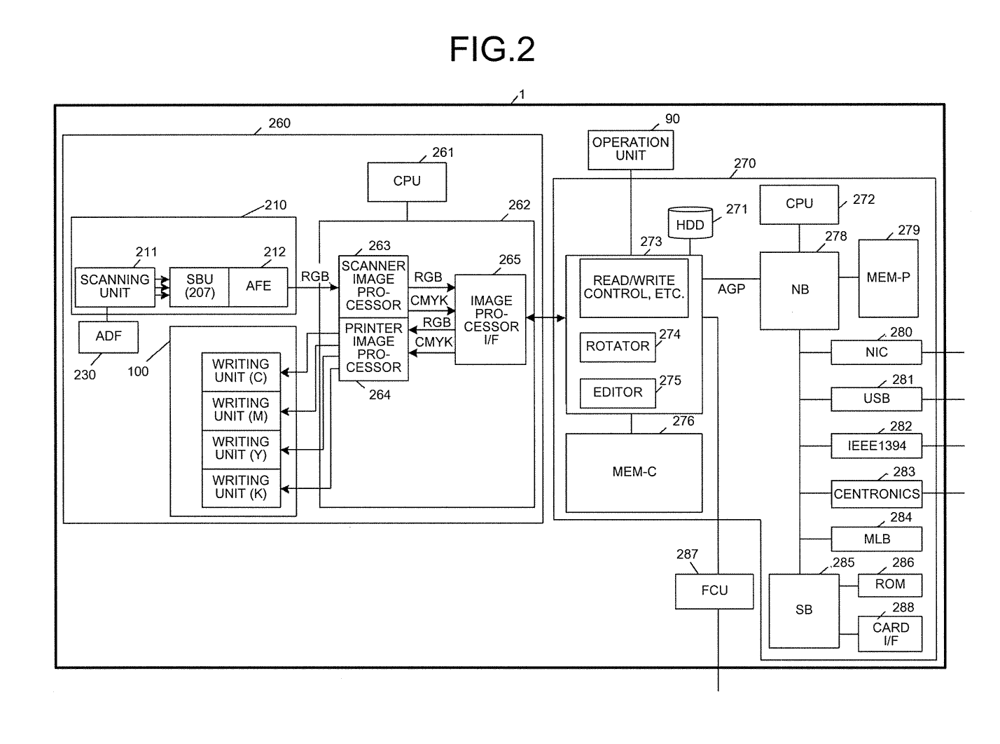

FIG. 1 is a front view of a full-color digital multifunction product (MFP) 1 as an image forming apparatus according to an embodiment of the present invention. FIG. 2 is a block diagram of an image processing system of the MFP 1. The MFP 1 includes an automatic document feeder (ADF) 230, an operation unit 90, a color scanner 210, and a color printer 100. The operation unit 90 and the scanner 210 equipped with the ADF 230 are units that can be separated from the printer 100. The scanner 210 includes a control board that has a power device driver, a sensor input, and a controller, and directly or indirectly communicates with a CPU 261 to be timing-controlled to read an original image.

A controller board 270 to which is connected the printer 100 is connected via a local area network (LAN) to a personal computer PC. A facsimile control unit FCU 287 is connected to an exchanger PBX via a telephone line PN (facsimile communication line). Print is discharged from the printer 100 to a paper stack.

Referring to FIG. 2, the MFP 1 includes, as the image processing system, an engine 260 that reads an original image and performs color print, the controller board 270, and the operation unit 90. The engine 260 includes the CPU 261 that controls processes of the image reading and print, the scanner 210, the printer 100, and an image input/output processor 262 that is implemented by an application specific integrated circuit (ASIC).

The scanner 210 includes a scanning unit 211, and an analog front end (AFE) 212. On a sensor board unit of the scanner 210 are provided a CPU, a read only memory (ROM), and a random access memory (RAM). The CPU controls the scanner 210 by loading a computer program from the ROM into the RAM and executing the computer program. Further, connected to the CPU 261 for a process control through a communication line, operation according to instructions or commands and data communication is performed. The CPU in the scanner 210 performs detection of an original detecting sensor, an HP sensor, a pressure plate open/close sensor, and a cooling fan, and controls ON/OFF. In the scanner 210, a scanner motor driver is driven by a pulse width modulation (PWM) output from the CPU to generate an excitation pulse sequence, and drives a pulse motor for an original scanning drive.

An original is irradiated with from a light source such as a halogen lamp that is energized by a lamp regulator. Reflection light from the original, in other words, a light signal, passes a plurality of mirrors and lenses and is imaged by a charge coupled device (CCD) 207 that includes three line sensors for red (R), green (G), and blue (B) reading. The three-line CCD 207 is provided with respective driving clocks by an image signal processing circuit (the AFE 212) on the sensor board unit SBU, and outputs an analog image signal of each pixel of each of RGB to the AFE 212. The AFE 212 converts the image signal into digital data, that is, image data.

The controller board 270 includes a CPU 272, a document accumulation controller 273, an HDD 271, a local memory (MEM-C) 276, a system memory (MEM-P) 279, a north bridge (NB) 278, a south bridge (SB) 285, a network interface card (NIC) 280, a universal serial bus (USB) 281, an IEEE1394 interface 282, a Centronics interface 283, and a ROM 286. The document accumulation controller 273 can be implemented by ASIC, and includes a rotator 274 and an editor 275. The operation unit 90 is connected to the document accumulation controller 273. The FCU 287 is also connected to the document accumulation controller 273 through a peripheral component interconnect (PCI) bus.

The CPU 272 can communicate document data with the personal computer PC or a server that is connected to the LAN through the NIC or with a personal computer or a server through the Internet. The CPU 272 can also communicate with a personal computer, a printer, a digital camera, and the like through the USB 281, the IEEE1394 interface 282, and the Centronics interface 283.

The south bridge 285, the NIC 280, the USB 281, the IEEE1394 interface 282, the Centronics interface 283, and a media link board (MLB) 284 are connected to the north bridge 278 through the PCI bus. Thus, the MLB 284 is a board that is connected to the engine 260 through the PCI bus. The MLB 284 converts input data into image data, and outputs the converted image data to the engine 260.

To the document accumulation controller 273 are connected the local memory 276, the HDD 271, and the like, and the CPU 272 and the document accumulation controller 273 are connected through the north bridge 278 in a CPU chip set. The document accumulation controller 273 and the north bridge 278 are connected through an accelerated graphics port (AGP).

The CPU 272 controls the MFP 1. The north bridge 278 is connected to the CPU 272, the system memory 279, the south bridge 285, and the document accumulation controller 273. The system memory 279 is used as a graphic memory of the MFP 1. The south bridge 285 is connected to the north bridge 278 and peripheral devices through the PCI bus. To the south bridge 285 is connected a card interface (I/F) 288 for reading data from and writing data to an external ROM and a secure digital (SD) memory card (hereinafter, “SD card”). To the card I/F 288, an SD card read/write device (card reader) is connected, and read of data in the SD card that is connected to the card reader and write of data therein are enabled.

The local memory 276 is used as an image buffer and a code buffer for copies. The HDD 271 stores therein management information such as communication log and print log, image data, text data, computer programs, font data, forms, and look up table (LUT). The operation unit 90 receives input provided by a user and displays information for the user.

A flow of image data among the scanner 210, the printer 100, and the image input/output processor 262 is explained below. The image input/output processor 262 includes a scanner image processor 263 that performs shading correction, scanning gamma correction, and modulation transfer function (MTF) correction on each of RGB image data that are generated by scanning an original image by the scanner 210, and that converts the corrected RGB image data into C, M, Y, and K print color data as necessary, and a printer image processor 264 that converts the RGB image data or cyan (C), magenta (M), yellow (Y), and black (K) print color data into CMYK print data that are suitable for writing units of different colors of C, M, Y, and K, and an image processing interface (I/F) 265 that outputs original scanning image data RGB or CMYK to the document accumulation controller 273, and provides the printer image processor 264 with the image data RGB or CMYK that are output by the document accumulation controller 273.

In the case of one-page copy in which one copy is printed for one original, the CMYK print color data is output from the scanner image processor 263 to the image processing I/F 265, the image processing I/F 265 outputs the image data to the printer image processor 264, and the printer image processor 264 performs magnification change and image processing as necessary, and performs printer gamma conversion and tone processing to output to each writing unit (laser-light emitter).

In the case of continuous copy in which a plurality of copies are printed for one original, the CMYK print color data is output from the scanner image processor 263 to the image processing I/F 265, the image processing I/F 265 outputs the image data to the document accumulation controller 273. The image data is temporarily stored in the local memory 276 or the HDD 271, and is read out for each copy to be provided to the printer image processor 264 from the document accumulation controller 273 through the image processing I/F 265. The printer image processor 264 performs magnification change and image processing as necessary, and performs printer gamma conversion and tone processing to output to each writing unit.

Upon the scanner 210 scanning and registration, or transmission to an external unit, the RGB image data output from the scanner image processor 263 is registered in the HDD 271 through the image processing I/F 265 and the document accumulation controller 273, or is once stored in the local memory 276 or the HDD 271 and then transmitted to an external unit.

When the printer 100 is performing printing of the registered RGB image data or the RGB image data externally received, the RGB image data is provided to the printer image processor 264 through the document accumulation controller 273 and the image processing I/F 265. The printer image processor 264 converts the RGB image data into the CMYK print color data, and then performs magnification change and image processing as necessary, and performs printer gamma conversion and tone processing to output to each writing unit.

Print data provided from the personal computer PC or the server is converted into bitmap data for printing by the controller board 270, and stored in the memory 276 or the HDD 271 through the document accumulation controller 273. The data is then provided to the printer 100 through the image input/output processor 262 to be printed by the printer 100. A log of print jobs (including print of output of the scanner 210, i.e., copy print) in response to input by a user through the operation unit 90 and of print jobs (access log in print commands) received from the personal computer PC or the server, and a print log (state-change log generated by print job) that indicates contents of such jobs are stored in the HDD 271.

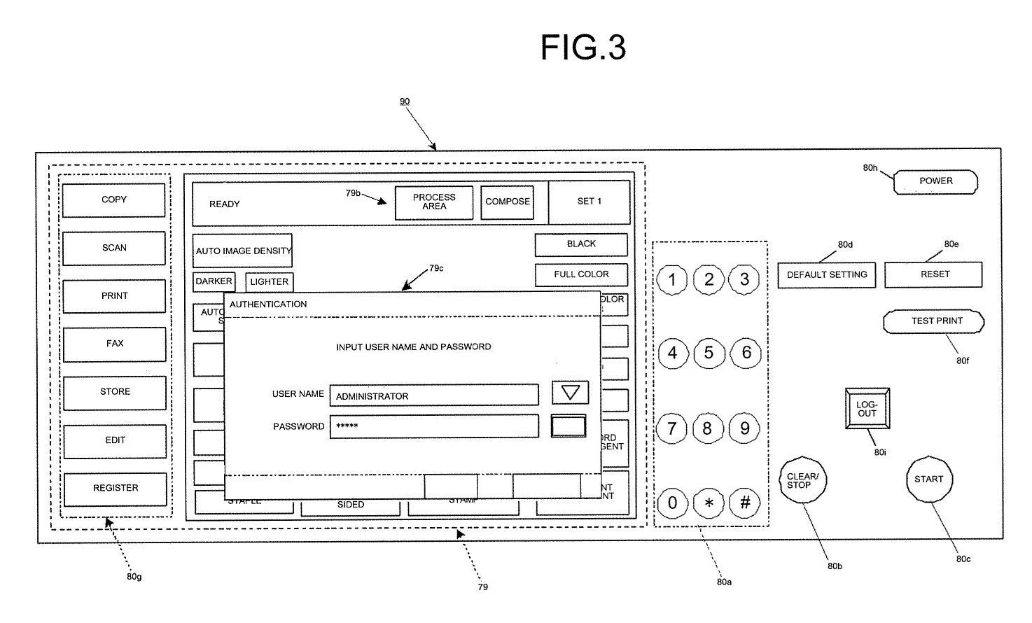

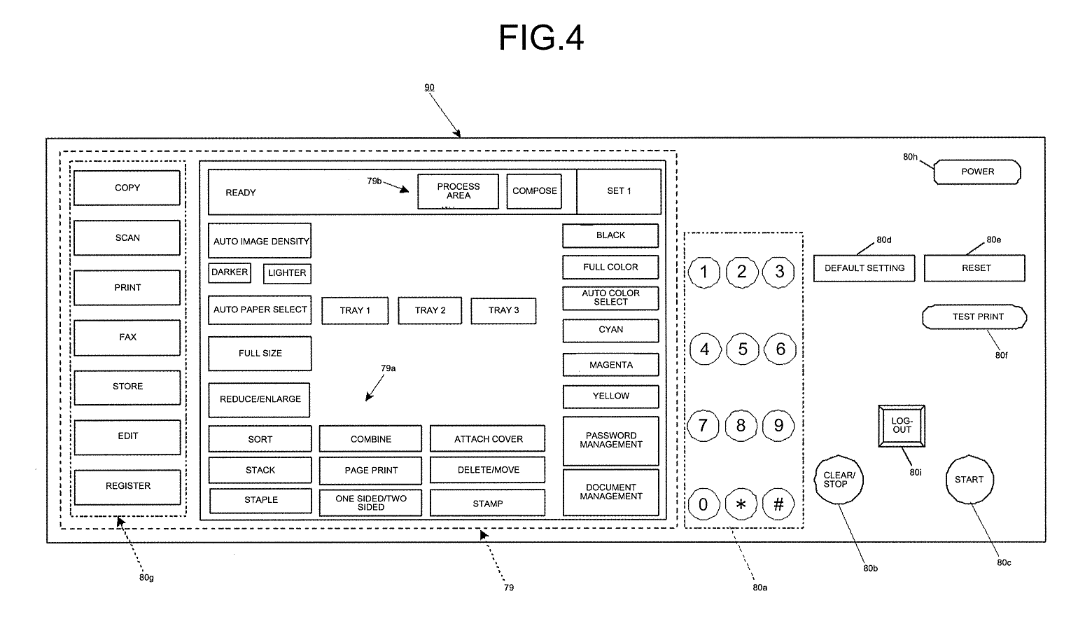

FIGS. 3 and 4 are examples of input screens displayed by the operation unit 90. The operation unit 90 includes a liquid-crystal touch panel 79, a numeric keypad 80a, a Clear/Stop key 80b, a Start key 80c, a Default Setting key 80d, a Reset key 80e, and a Test Print key 80f. Although not shown, an keyboard for input and setting related to a uniform resource locator (URL), an email content, a file name, a folder name, and the like, and for shortcut registration is provided.

The Test Print key 80f is used to print only one page regardless of the set number of pages to be printed to check a print result. The Default Setting key 80d is used to customize the default settings. The Reset key 80f is used to clear the current entry or reset various parameters to default settings. When the Default Setting key 80d is pressed, selection buttons to designate such functions as “default parameter setting” function to set various default parameters, “log management” function, “user rule registration” function, “server/client” setting function, “usage record output” function are displayed. In addition, an application that is selected by priority when no operation is performed for a predetermined time, setting of a time to transit to a low power mode according to International Energy Star Program, and setting of time to transit to an automatic off/sleep mode are possible.

The touch panel 79 displays various function keys, messages that indicate a state of the image forming apparatus, and the like. On the touch panel 79, function selection keys 80g to select “copy” function, “scanner” function, “print” function, “facsimile” function, “storage” function, “edit” function, “registration” function, “combine” function, and is the like are displayed. An input/output screen fixed to a function designated by the function selection key 80g is displayed. For example, when the “copy” function is designated, as shown in FIG. 4, function keys 79a and 79b, and a message that indicates the number of pages and the state of the image forming apparatus are displayed. By touching a key displayed on the touch panel 79, the key that indicates the selected function is displayed in reverse to be gray. When it is required to specify details of the function (a type of page printing, etc.), a setting screen of detailed functions are displayed by touching the key. As described above, because the touch panel 79 employs a dot display, an optimal display at each time can be graphically performed.

When an operating voltage is applied to the operation unit 90, the operation unit 90 shifts from the power save mode to the operation mode, and displays an input screen (input blocks for a user name and a password are blank being in a state before input) shown in FIG. 3 on the touch panel 79. When a user inputs the user name and the password, and clicks a “Login” key, the input data is provided to an authentication service (software) installed on the operation unit 90. If the input user name and the password are those registered in the authentication service, an input screen shown in FIG. 4 from which a user information input screen 79c is deleted, and in which a key-in is accepted is displayed on the touch panel 79. Authorization herein is classified into two categories of administrator that has administration authority and others that have no administration authority.

When a Logout key 80i is pressed, the CPU 272 displays the login input screen 79c on the touch panel 79 the display on the touch panel 79 is returned to the input screen shown in FIG. 3. Thus, a key-in is disabled (use of the MFP 1 is impossible) on the operation unit 90 unless a registered user name and a password are input. Also when the input enabled state shown in FIG. 4 continues a predetermined time without any input while the MFP 1 is in standby mode, the CPU 272 returns the display of the touch panel 79 to the input screen displaying the login input screen 79c shown in FIG. 3 by timeout initialization.

If a user inputs a user name and a password with administrator authority, when the Default Setting key 80d shown in FIG. 4 is pressed, the operation unit 90 displays a default setting menu on the touch panel 79. The menu includes processing items of the “log management”, registration and setting of others, and data storage/release. Hereinafter, a user that has a user name and a password with administrator authority is referred to as an administrator.

The “log management” defines transfer (write to an external memory) of a part or an entire of a log that indicates use records of the printer 100, delete thereof, and handling of a print command when there is a possibility that the accumulated log exceeds the limit.

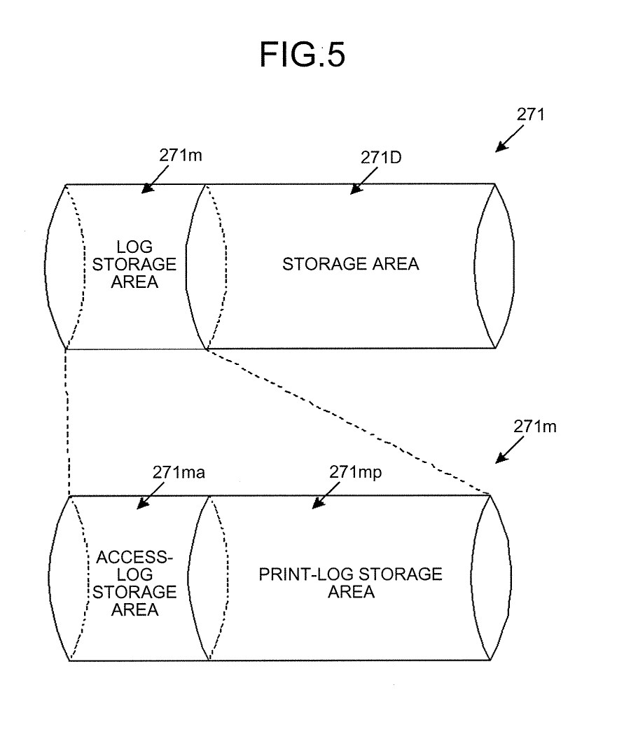

FIG. 5 is a schematic diagram of a log storage area 271m on the HDD 271 that stores therein log data of print jobs. The HDD 271 has the log storage area 271m whose size is fixed and a storage area 271D for other data are set. The log storage area 271m is divided into two areas of an access-log storage area 271ma and a print-log storage area 271mp. The area boundary value is fixed. In other words, the sizes of both of the areas 271ma and 271mb are fixed. The access log is data that indicates accesses to the apparatus such as login, logout, date, time, user identification (ID), document name, document creation, print, and erasure. The print log is state change data (reception completion of each page, print completion, etc.) during printing. The access log and the print log are stored in the HDD 271 as log data, however, because the storage areas of the access log and the print log are separately used in the log storage area of the HDD 271, the access log and the print log are never stored beyond the boundary.

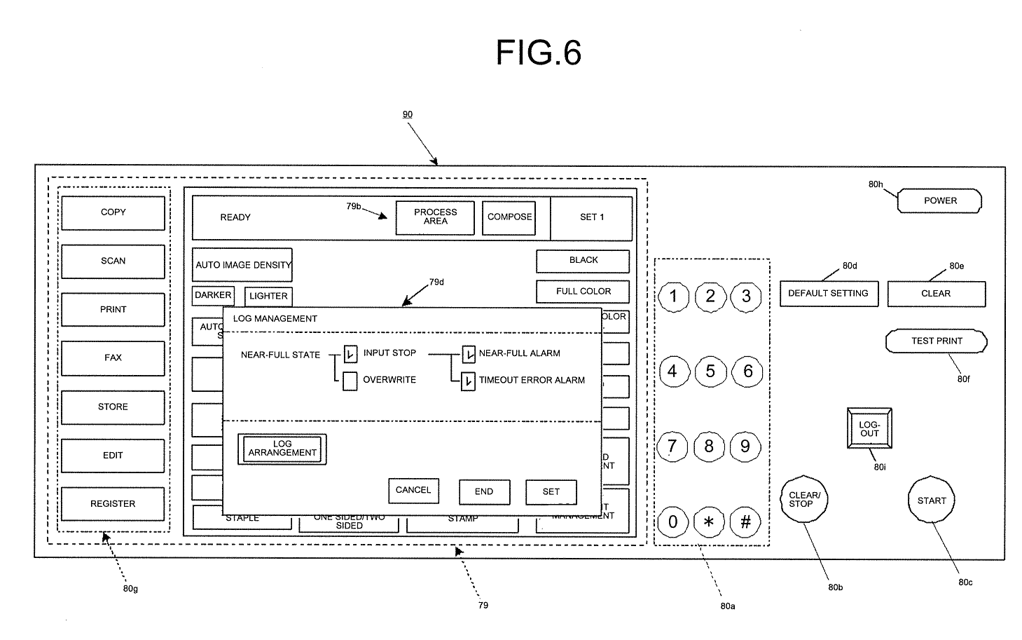

When the “log management” item on the default setting menu is selected (designated), the operation unit 90 displays the input screen 79d of the “log management” shown in FIG. 6 on the touch panel 79. In the input screen 79d, a section in which operation with respect to a print job request is designated when the log storage area 271m is in a “near-full” state in which available space in the access-log storage area 271ma or the print-log storage area 271mp is less than a sufficient size (set value) to add a log of one print job, and a “log arrangement” button are displayed. With the input screen 79d, a user can select operation in the near-full state, i.e., “input stop” or “overwrite”. When “input stop” is selected, “near-full alarm” and “timeout-error alarm” can be independently specified. Out of “input stop” and “overwrite”, “input stop” is set as default. Upon selecting “overwrite”, designation of “input stop” is automatically cancelled. If “overwrite” is selected, when there is no available space in the access-log storage area 271ma or the print-log storage area 271mp, a new log is automatically overwritten on an old log storage area. Upon selecting “input stop” in a state where “overwrite” is designated, “overwrite” is automatically cancelled. Selection on “near-full alarm” and “timeout-error alarm” can be made only when “input stop” is designated. When the “log arrangement” button is clicked, the operation unit 90 displays the log edit screen. With this log edit screen, a user can perform printing, transfer to a server or an external memory, delete, or the like of an existing log.

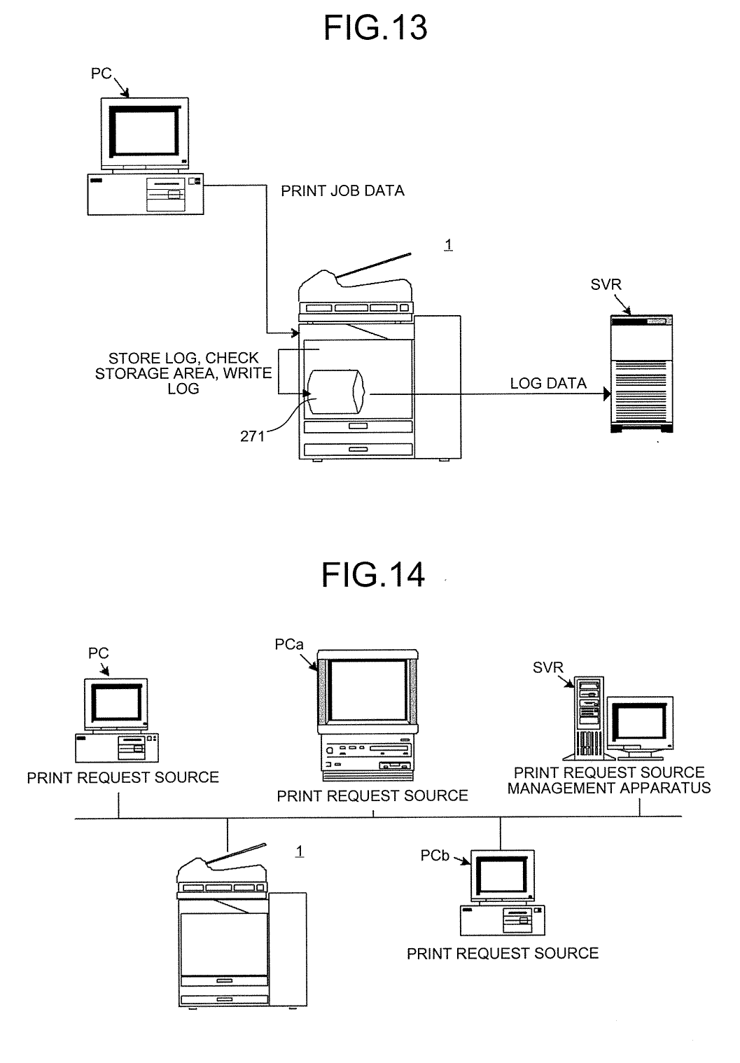

For example, a print job (command) is issued to the MFP 1 by a user providing input through the operation unit 90 to copy or print out data stored in the MFP 1. A Print command can also be issued by providing print data to the MFP 1 from the personal computer PC as shown in FIG. 12. If operating utility software is loaded in the personal computer PC, the MFP 1 can be operated using the personal computer PC, similarly to the case of using the operation unit 90. In this case, the instruction is to make a copy using the scanner 210, or to print out a stored document. In either case, a log of the print job is stored in the HDD 271. In another case, the MFP 1 stores therein a log of a printing process corresponding to a received print job in the HDD 271 as shown in FIG. 13. The log stored in the HDD 271 is sent to a server SVR and stored therein. FIG. 14 depicts the case where print job data is sent to the MFP 1 from a plurality of devices (personal computer, server, etc.) through a network.

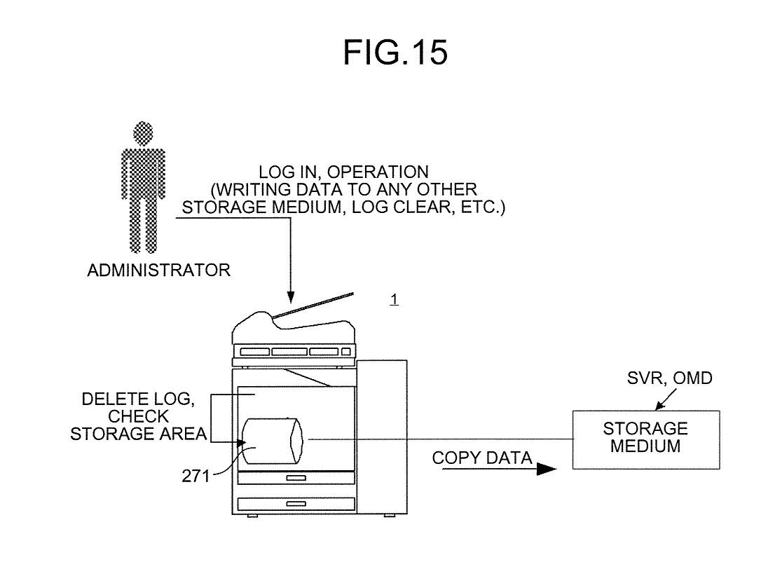

FIG. 15 is one example of an operation performed by the administrator with respect to logs stored in the MFP 1. The administrator logs in the MFP 1 to operate the MFP 1. At logging in, a password is required. After logging in, the administrator writes a log stored in the HDD 271 to another recording medium (for example, a server or an external memory) to secure a log storage area, and deletes the log that has become unnecessary to be stored in the HDD 271 from the HDD 271.

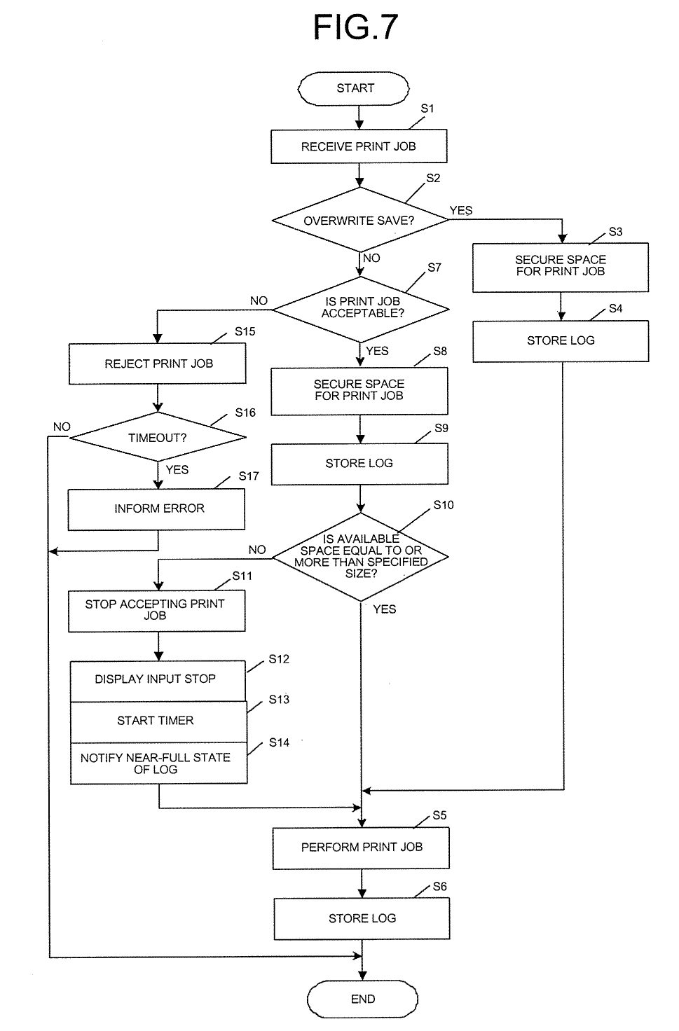

FIG. 7 is a flowchart of a print job process performed by the CPU 272 together with the document accumulation controller 273. Upon receiving a print job (print command) (step S1), the CPU 272 refers to the setting of the “log management” (step S2), and if it is set to “overwrite save”, secures a space necessary for the print job in the access-log storage area 271ma and the print-log storage area 271mp in the HDD 271 (step S3). When there is no space, a required space occupied by the oldest log is determined as a space (overwriting area) for a log of the print job. In the access-log storage area 271ma, an access log (date, time, user ID, etc.) of the print job is stored (step S4). The print job is then performed (step S5), and a state-change log during printing is stored in the print-log storage area 271mp (step S6).

If the “log management” is set to “input stop”, it is checked whether the log storage area 271m is in the near-full state and the print job is not acceptable (steps S2 and S7). When the print job is acceptable, a space necessary for the print job is secured in the access-log storage area 271ma and the print-log storage area 271mp in the HDD 271 (step S8). In the secured space, the log of the print job (date, time, user ID, etc.) is stored (step S9). An available space in the access-log storage area 271ma and the print-log storage area 271mp is then checked whether it is equal to or more than a specified size (step S10). If the available space is less than the specified size in either of them, a print job is not to be accepted (step S11), and input stop due to the near-full state is specified and displayed on the touch panel 79 (step S12). If “timeout-error alarm” is set in the “log management”, a timer is started (step S13), and if “near-full alarm” is set, a notice of the near-full state is sent to an email address of the administrator (step S14). The print job is then performed (step S5), and the state-change log during printing is stored in the print-log storage area of this time (step S6).

When input stop has been specified, upon receiving a print job, the CPU 272 rejects the print job (step S15). If the timer has been started due to the detection of the near-full state, and then the timer times out (step S16), the personal computer PC, which has requested the print job, is informed of a printer error, and the touch panel 79 displays the printer error due to the near-full state of logs (step S17).

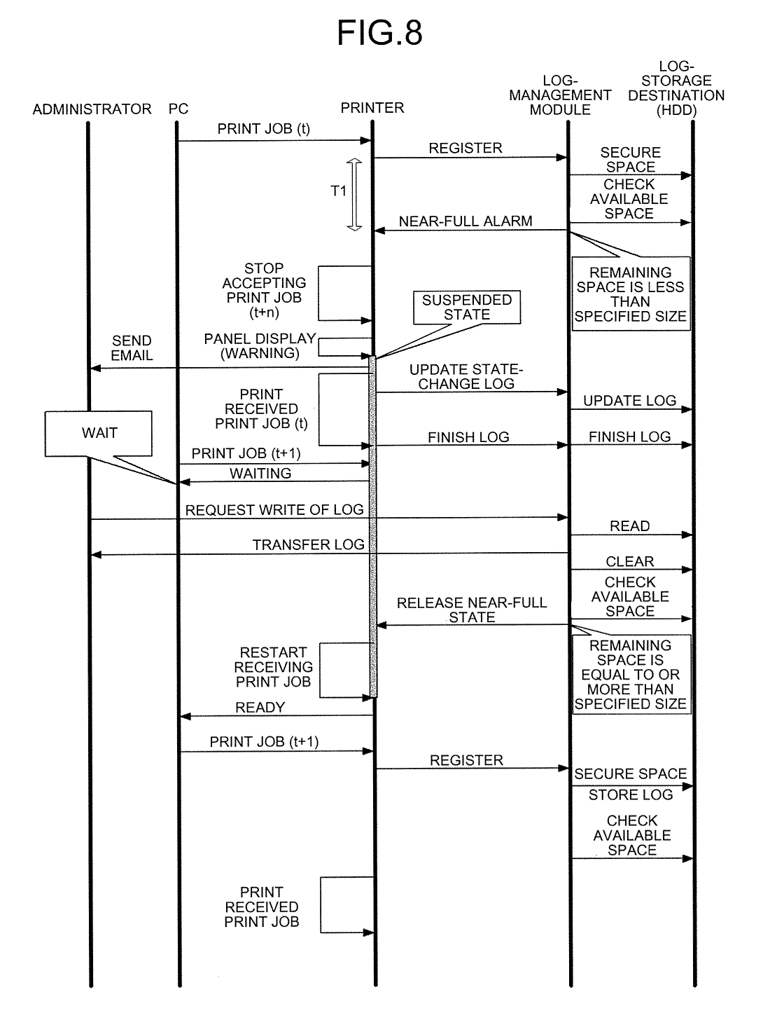

FIG. 8 is a timing chart of operation in the near-full state. When a print job is sent from the personal computer PC, a source of print data, to the MFP 1, the MFP 1 receives the print job if it is acceptable. Upon receiving the print job, a space necessary to store a log of the print job is secured first. The log (date, time, user ID, document name, etc.) of the print job is then stored.

After the space necessary for the print job is secured, a remaining space in the print-log storage area is checked. If the remaining space is less than a specified size, a near-full alarm is issued.

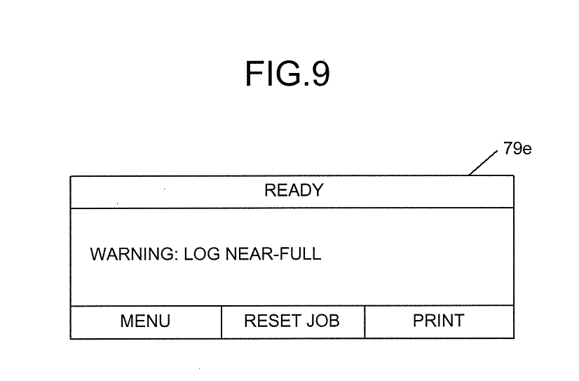

FIG. 9 is an example of a warning screen 79e for the near-full state that is displayed on the touch panel 79.

The warning is issued at the point of the near-full state not a full state because, to the MFP 1, print jobs may not sequentially sent from a single unit. Even when a single unit, e.g., the personal computer PC, is connected to the MFP 1 as shown in FIG. 12, jobs can be sent at the same time from the scanner 210 of the MFP 1 and the personal computer PC. Further, when a plurality of personal computers PC, PCa, PCb, and the server SVR are connected to a LAN to which the MFP 1 is connected as shown in FIG. 14, print jobs can be issued at the same time by two or more of them. Therefore, a print job can be received during time T1 from registration of an access log to notice of the near-full state. In the case of detecting a full sate (no space in the log storage area), a space for the print job received during time T1 cannot be secured in the print-log storage area and the log is lost. Therefore, the warning is issued at the near-full state.

After detecting the near-full state, the MFP 1 stops accepting a print job, and enters in a suspended state. If a print job arrives at this time, a message “waiting” is sent to a host (personal computer or server) that has sent the print job so that the host waits until receiving a message “ready”. While the acceptance of a new print job is stopped, because a space to store the log is secured at first for the print job that has already been received, printing and storing the log of the print job are performed. A log at the time of printing is stored in the secured space. As a log during printing, the state-change log (information on reception completion of each page, print completion, etc.) is stored. A notice of the near-full state is displayed on the touch panel 79, and email is sent to the administrator.

When the administrator deletes logs from the HDD 271 to release the near-full state, and as a result, a space equal to or more than the specified size is created in the log storage area, the CPU 272 cancels suspension due to the near-full state. Accordingly, the MFP 1 becomes possible to receive a print job, and a message “ready” is sent to the host to which the message “waiting” has been sent. Upon receiving the message “ready”, the host issues again the print job.

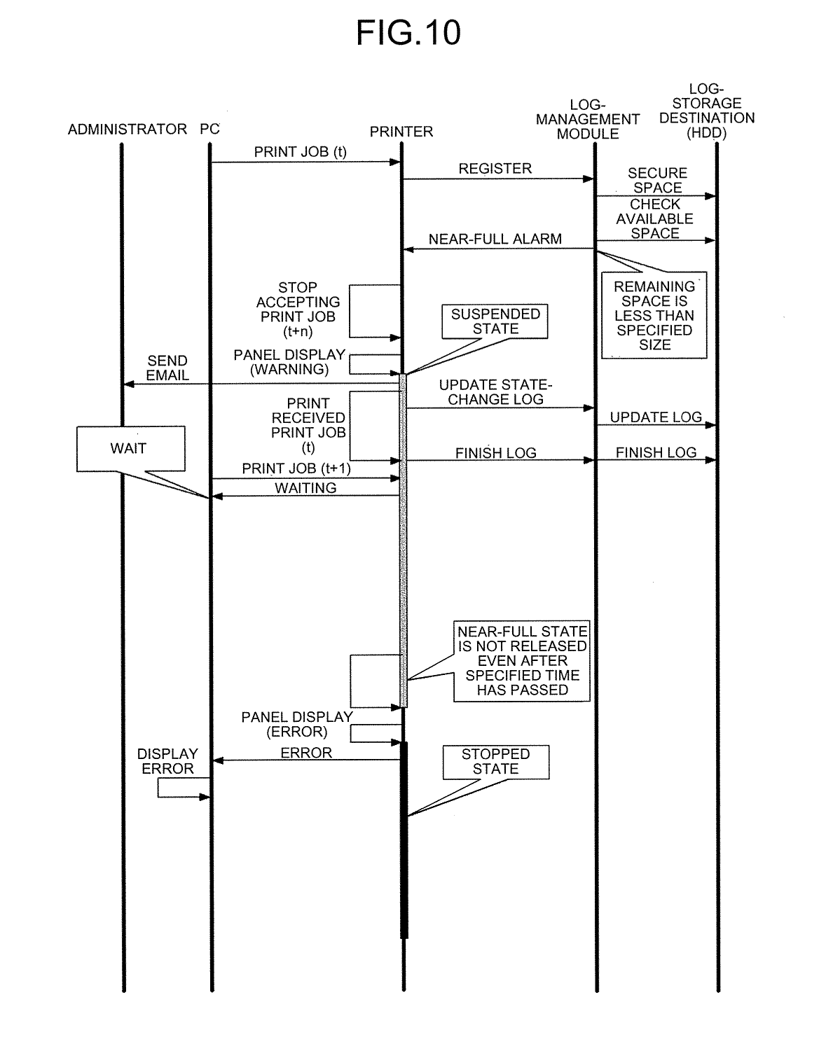

FIG. 10 is another timing chart for explaining timing to send a notice of an error to a user when timeout occurs after a continuous near-full state. When the near-full state is not solved due to absence of the administrator or the like, a user only receives the message “waiting” and cannot know that print is disabled. Therefore, when a predetermined time has passed, the user is notified that printing is disabled, thereby urging cancellation of the print job. The MFP 1 also becomes a stopped state from the suspended state, and returns an error message without receiving a new print job.

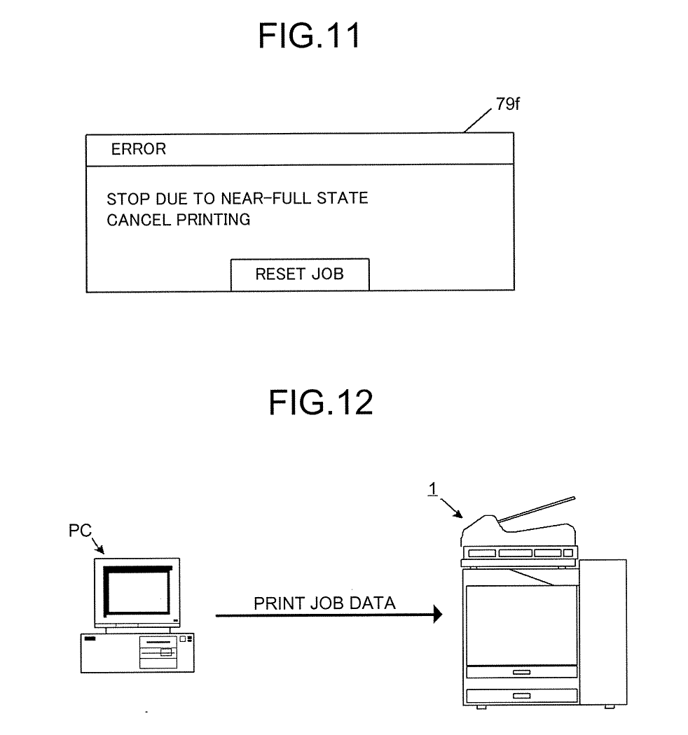

FIG. 11 is an example of an error-display screen 79f that is displayed on the touch panel 79 when timeout error occurs after the predetermined time passes in the near-full state.

While the log management for print jobs received from the personal computer PC is mainly explained above, the same applies to printing of a stored document in response to a print command input through the operation unit 90. For example, upon receipt of a print command through the operation unit 90, if a space equal to or more than the specified size is not available in the log storage area 271m in the HDD 271 for storing the access log (equivalent to a receipt log), a print job is not to be received thereafter, and an image forming process and storage of a log of print data of the print job that has been received are performed. Similarly, when a print job is received from the personal computer PC or the server, and a space equal to or more than the specified size is not available in the log storage area 271m for storing the receipt log in the log storage area 271m, a print job is not to be received thereafter, and an image forming process and storage of a log of print data of the print job that has been received are performed.

As set forth hereinabove, according to an embodiment of the present invention, a print job is rejected at the point of near-full state, not at the point when the log storage area is fully occupied or there is no space in the log storage area. Thus, loss of a log can be prevented.

Moreover, an administrator can easily recognize that log management is necessary. When a space is not secured because of absence of the administrator or the like, a user can be notified that printing is currently not available.

Furthermore, if the near-full state is not released even after a predetermined time has passed, the user can be notified of the timeout error.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming method comprising:
receiving a print job;
storing a first log of receipt of the print job in a storage unit;
checking, after the storing, whether an available space on the storage unit is equal to or more than a predetermined size;
suspending receipt of a new print job when the available space is less than the predetermined size;
converting print data of the print job to image data;
forming an image based on the image data; and
storing a second log of formation of the image in the storage unit.

2. An image forming apparatus comprising:
a communication unit that receives a print job;
a converting unit that converts print data of the print job to image data;
an image-forming unit that forms an image based on the image data;
a storage unit that stores therein a first log of receipt of the print job and a second log of formation of the image; and
a control unit that checks, after the first log is stored in the storage unit, whether an available space on the storage unit is equal to or more than a predetermined size, and suspends receipt of a new print job when the available space is less than the predetermined size.

3. The image forming apparatus according to claim 2, further comprising:
a reading unit that receives a print job by reading an original image to generate image data for the print job; and
an operation unit that receives input of an instruction with respect to the image data, wherein
the storage unit stores therein a third log of receipt of the print job received by the reading unit, and
the control unit that checks, after at least one of the first log and the third log is stored in the storage unit, whether an available space on the storage unit is equal to or more than a predetermined size, and suspends receipt of a new print job when the available space is less than the predetermined size.

4. The image forming apparatus according to claim 2, wherein the control unit secures a space necessary to store any one of the first log and the third log in the storage unit on receipt of the print job, and checks, after securing the space, whether an available space on the storage unit is equal to or more than a predetermined size.

5. The image forming apparatus according claim 3, wherein
the operation unit receives input of an instruction to delete a log for log management, and
the control unit deletes the log from the storage unit in response to the instruction.

6. The image forming apparatus according to claim 5, wherein the control unit suspends receipt of a new print job until a space equal to or more than the predetermined size becomes available in the storage unit.

7. The image forming apparatus according to claim 2, further comprising a warning unit that issues a warning when the control unit suspends receipt of a new print job.

8. The image forming apparatus according to claim 3, wherein
the operation unit receives input of setting related to suspension of receipt of a new print job, and
the control unit suspends receipt of a new print job when the available space is less than the predetermined size based on the setting.

9. The image forming apparatus according to claim 3, wherein the control unit sends an error message to a source the print job when receipt of a new print job is suspended for a predetermined time period.

10. The image forming apparatus according to claim 9, wherein
the operation unit receives input of setting related to the error message, and
the control unit sends the error message to a source the print job based on the setting.

11. An image forming system comprising:
a host that issues a first print job, and a second print job after the first print job; and
an image forming apparatus that includes
a communication unit that receives the first print job from the host;
a converting unit that converts print data of the first print job to image data;
an image-forming unit that forms an image based on the image data;
a storage unit that stores therein a first log of receipt of the first print job and a second log of formation of the image; and
a control unit that checks, after the first log is stored in the storage unit, whether an available space on the storage unit is equal to or more than a predetermined size, suspends receipt of the second print job when the available space is less than the predetermined size, and sends an error message to the host to notify the host of suspension of receipt of the second print job, wherein
the host displays the error message on a display unit.

12. The image forming system according to claim 11, wherein the image forming apparatus further includes
a reading unit that receives a print job by reading an original image to generate image data for the print job; and
an operation unit that receives input of an instruction with respect to the image data, wherein
the storage unit stores therein a third log of receipt of the print job received by the reading unit, and
the control unit that checks, after at least one of the first log and the third log is stored in the storage unit, whether an available space on the storage unit is equal to or more than a predetermined size, and suspends receipt of a new print job when the available space is less than the predetermined size.
